(19) United States
(12) Patent Application Publication
(10) Pub. No.: US 2017/0072560 A1
(43) Pub. Date: Mar. 16, 2017

(54) SAFETY OF A HUMANOID-TYPE ROBOT

(71) Applicant: SOFTBANK ROBOTICS EUROPE, Paris (FR)

(72) Inventor: Vincent CLERC, CLAMART (FR)

(21) Appl. No.: 15/310,433

(22) PCT Filed: Jun. 3, 2015
(86) PCT No.: PCT/EP2015/062458

§ 371 Date: Nov. 10, 2016

(30) Foreign Application Priority Data
Jun. 3, 2014 (FR) 1455027

(51) Int. Cl. B25J 9/10; B25J 19/06

(52) U.S. Cl. CPC B25J 9/101; B25J 19/06; Y10S 901/13

(57) ABSTRACT

A humanoid-type robot comprises two elements and an articulation with at least one degree of freedom linking the two elements, the articulation allowing a travel in a given range in operational operation, a first of the two elements being intended to come into contact with an abutment belonging to a second of the two elements at the end of the range. According to the invention, the robot further comprises at least one switch. The switch is configured to actuate an electrical contact when a force exerted by the first element against the abutment exceeds a given force.

The invention relates to the safety of use of a humanoid-type robot.

A robot can be qualified as humanoid from the moment when it has certain attributes of the appearance and functionalities of a human being, such as, for example, a head, a trunk, two arms, two hands, two legs or two feet. Some robots that have only the top of the body can also be considered to have humanoid characteristics. There are humanoid robots capable of walking or of moving on a platform provided with wheels, of making gestures with the limbs or with the head. The complexity of the gestures that they are capable of performing is constantly increasing. Despite such progress, humanoid robots remain susceptible to fall. These falls can occur during robot development trials, but also in a subsequent phase of use of the robot, because of the inevitable obstacles or external interventions. The robots can also receive impacts either through their own movements or because of animated external elements.

In falls or upon impacts, a robot can lose control of its movements and cause damage to its surroundings.

The invention aims to mitigate this problem by means of a device allowing for an emergency stop of the robot.

To this end, the subject of the invention is a humanoid-type robot comprising two elements and an articulation with at least one degree of freedom linking the two elements, the articulation allowing a travel in a given range in operational operation, a first of the two elements being intended to come into contact with an abutment belonging to a second of the two elements at the end of the range, characterized in that it further comprises at least one switch configured to actuate an electrical contact when a force exerted by the first element against the abutment exceeds a given force.

The switch can be situated in the abutment or in the vicinity thereof.

The two elements and the articulation can be configured to deform at least one of the two elements or the articulation under the action of the force exceeding the given force, the deformation actuating the electrical contact.

The electrical contact is advantageously implemented in an emergency stop device which can be actuated by the robot itself through its own movements, in case of impact or of a fall, or which can be actuated by an external operator wishing to take the robot out of service, for example after having observed untimely movements of the robot. In other words, the abutment and its switch form an emergency stop button of the robot and the robot advantageously comprises electrical power supply means. The electrical contact is then configured to deactivate the electrical power supply means upon the actuation of the electrical contact.

Advantageously, the abutment is flexible and the electrical contact is actuated by a deformation of the abutment. The abutment can have a stiffness characterizing its flexibility, the stiffness of the abutment being gauged to obtain the actuation of the electrical contact for a given force exerted on the abutment.

In one embodiment, the robot comprises a flexible membrane forming a skin of the second element, the switch being arranged inside the second element under the skin. The abutment can comprise a spacer bearing on the one hand on a mobile part of the switch and on the other hand on the flexible membrane.

The switch comprises a mobile part and a fixed part (29) fixed to a supporting structure of the second element. The switch (23) advantageously forms a pushbutton operated by displacement of the mobile part in translation along an axis relative to the fixed part.

In a preferred embodiment, the first of the two elements forms a head of the robot and the second of the two elements forms a trunk of the robot.

According to a variant of this preferred embodiment, the robot is configured so that any force of the head on the trunk exceeding a given force according to any axis of rotation in a horizontal plane of the robot, actuates the electrical contact of the switch. The abutment can comprise a flange ring extending around a vertical axis of the robot, the flange ring ensuring the transmission of the force of the head against the abutment to the switch.

According to another variant of this preferred embodiment, the abutment is arranged in a sagittal plane of the robot and the electrical contact is arranged so as to be actuated upon a rotational movement of the head relative to the trunk about an axis substantially at right angles to the sagittal plane.

The invention will be better understood and other advantages will become apparent on reading the detailed description of an embodiment given by way of example, the description being illustrated by the attached drawing in which:

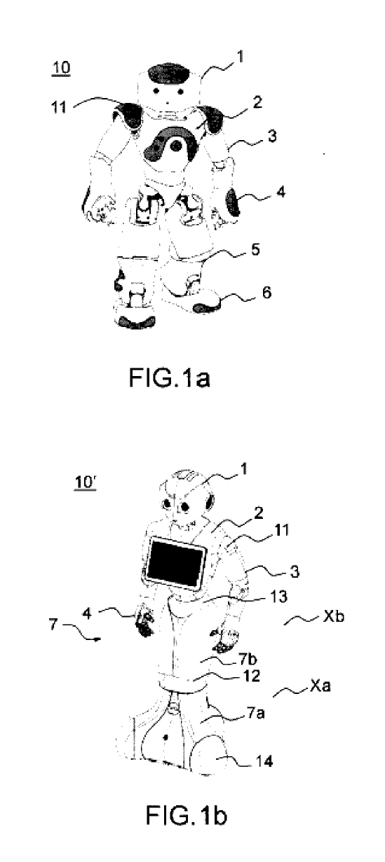

FIGS. 1a and 1b represent two examples of robots that can implement the invention;

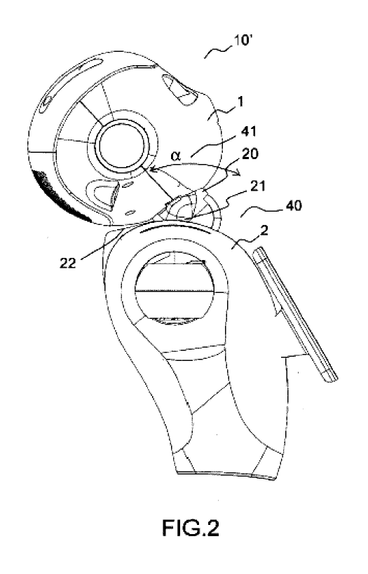

FIG. 2 represents, in cross section in a sagittal plane, the head and the trunk of the robot of FIG. 1b;

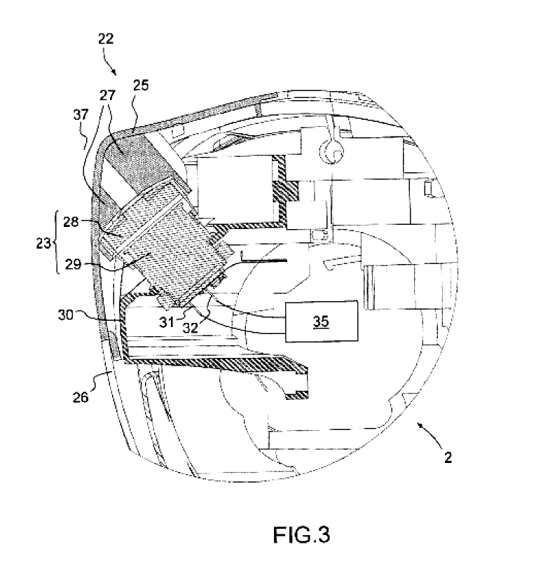

FIG. 3 represents, in partial cross section, in the sagittal plane of the robot of FIG. 1b, a part of the trunk;

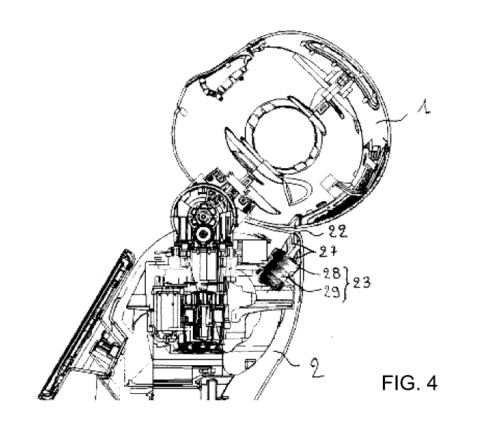

FIGS. 4, 5 and 6 represent the robot of FIG. 1b in different positions upon the operation of an emergency stop button.

For clarity, the different elements will bear the same references in the different figures.

FIGS. 1a and 1b represent two examples of humanoid-type robots developed by the company Aldebaran Robotics™. The humanoid robot 10 represented in FIG. 1a comprises a head 1, a trunk 2, two arms 3, two hands 4, two legs 5 and two feet 6. The humanoid robot 10′ represented in FIG. 1b comprises a head 1, a trunk 2, two arms 3, two hands 4 and a skirt 7. These two robots comprise a number of articulations allowing the relative movement of the different limbs of the robot in order to reproduce human morphology and its movements. The robots 10 and 10′ comprise, for example, an articulation 11 between the trunk 2 and each of the arms 3. The articulation 11 forming a shoulder of the robot is motorized about two axes of rotation to make it possible to displace the arm 3 relative to the trunk 2 in the manner of the possible displacements of a shoulder of a human being.

The humanoid-type robot 10 also comprises a number of articulations to move the legs of the robot and reproduce the walking movement, in particular articulations that can be likened to a hip, between the trunk and each of the thighs, to a knee, between a thigh and the leg, and to an ankle between the leg and the foot. Several forms of motorized articulation are implemented, driving the movement of one of the limbs according to one or more degrees of freedom in rotation.

The humanoid-type robot 10′ has a different architecture. To improve the stability and lower the center of gravity of the robot, the robot does not comprise legs but a skirt 7, comprising, at its base, a tripod 14 capable of moving the robot. The skirt 7 also comprises a first articulation 12 that can be likened to a knee, between a leg 7a and a thigh 7b. A second articulation 13 that can be likened to a hip is links the trunk 2 and the thigh 7b. These two articulations 12 and 13 are pivot links motorized about an axis of rotation. The axis of rotation Xa of the articulation 12 and the axis of rotation Xb of the articulation 13 are substantially parallel to an axis linking the two shoulders of the robot, making it possible to tilt the robot forward or backward.

FIG. 2 represents, in cross section in a sagittal plane, the head 1 and the trunk 2 of the robot 10′ of FIG. 1b. The head 1 and the trunk 2 are linked by a neck 20 forming an articulation with three degrees of freedom in rotation. The present invention is interested in the rotation that the neck 20 allows about an axis 21 at right angles to the sagittal plane of the robot, that is to say at right angles to the plane of FIG. 2. The neck 20 allows a rotation of the head 1 relative to the trunk 2 within a given angular range α, upon the operational operation of the robot 10′. In FIG. 2, the head 1 is in the vicinity of one of the ends of the angular range α. The head 1 is almost in contact with an abutment 22 belonging to the trunk 2. In other words, the face of the robot 10′ is raised and the head 1 is substantially bearing on the top of the back of the robot 10′.

The rotation of the head 1 can be obtained by means of an actuator making it possible to motorize the articulation of the neck 20 or by an external action, for example when an external force is exerted on the head 1 or upon a rapid movement of the head 1 driving the latter by inertia. In normal or operational operation of the robot 10′, the head 1 is displaced relative to the trunk 2 within the angular range α. Upon this operational operation, the head 1 can come to bear against the abutment 22 without exerting on the abutment 22 a force exceeding a force of given value. In other words, if the head 1 comes to exert on the trunk 2 a force greater than the given force, it is then considered that the robot is no longer in are operational operation. The exit from the context of operational operation can be due to an impact exerted on the robot 10′ driving the head in an abrupt movement which, by inertia, drives the head 1 against the trunk 2. This impact can be absorbed by the trunk 2 or directly by the head. The exit from operational operation can be due to an operating fault of the actuator of the articulation of the neck 20. Any other cause can be envisaged. One of the aims of the invention is to allow for the detection of the exit from operational operation when an excessive force is exerted by the head 1 on the trunk 2. It is of course possible to detect the exit from operational operation due to an untimely force of any mobile element of the robot relative to another element of the robot. In the example represented, the range is an angular range. It is possible to implement the invention between two elements of the robot that are mobile in translation relative to one another. The range can be linear or can even extend according to any curve followed relatively by the two mobile elements of the robot.

FIG. 3 represents, in partial cross section in the sagittal plane of the robot 10′, a part of the trunk 2, in which part the abutment 22 is located.

According to the invention, to detect the exceeding of a given force exerted hard the abutment 22, the robot comprises an electrical contact actuated in case of exceeding of the given force. An exemplary embodiment of this electrical contact is represented in FIG. 2. In this example, the abutment 22 is flexible and the electrical contact is formed in a switch 23 actuated by the deformation of the abutment 22. The abutment 22 has a stiffness characterizing its flexibility. More specifically, the stiffness can be defined by a coefficient of proportionality linking a force exerted on the abutment 22 and the deformation of the abutment 22. This coefficient can be can be constant or not as a function of the force. This coefficient is a function of the nature of the material or materials chosen to produce the abutment, notably of the Young's modulus of the material and of the dimensions of the material. The stiffness of the abutment 22 is gauged to obtain the actuation of the switch for a given force exerted on the abutment 22.

It is possible to incorporate in the abutment 22 a spring element making it possible to gauge the given force. This spring element can be arranged in the switch 23. In the example represented, the abutment 22 comprises a flexible membrane 25 forming a part of the skin of the trunk 2. The membrane 25 is for example produced on the basis of rubber or silicon. The membrane 25 can be in the continuity of another rigid part 26 of the skin of the trunk 2. The switch 23 can be placed directly under the membrane 25 or at a distance therefrom as represented in FIG. 3. The abutment 22 then comprises a spacer 27 bearing on the one hand on a mobile part 28 of the switch 23 and on the other hand on the membrane 25. The spacer 27 is shaped to press on the membrane 25 according to a desired form for the skin and to press on the mobile part 28 of the switch 23.

The switch 23 comprises a fixed part 29 fixed to a supporting structure 30 of the trunk 2. The fixed part 29 comprises two tongues 31 and 32 allowing the electrical connection of the switch 23. A force exerted on the abutment 22 is transmitted to the switch 23 via the spacer 27 and places the two tongues 31 and 32 in electrical contact. Alternatively, a force exerted on the switch 23 can open a contact that is normally closed in operational operation.

In the example represented in FIG. 3, the switch 23 is arranged in the abutment 22. Alternatively, it is possible to arrange the switch outside the abutment 22 in proximity thereto. It is thus possible to dissociate the switch function and the function of definition of the given force (that has to be exceeded to actuate the switch) ensured by the abutment itself.

According to another variant, it is possible to define the given force to be exceeded by means of elements other than the abutment. It is for example possible to retain a rigid abutment and allow a deformation of the different components linking the two elements 1 and 2 of the robot. It is for example possible to arrange the abutment in the articulation 22. In other words, a deformation of at least one component of the kinematic chain linking the two elements 1 and 2 is allowed. This deformation is obtained under the effect of a force greater than the given force. At least one of the components formed by the elements 1 and 2 themselves and the articulation 20 is configured to allow the desired deformation. This deformation is advantageously produced in an elastic domain in order to be reversible.

The robot 10′ comprises electrical power supply means 35. Advantageously, the electrical contact operated by the switch 23 is configured to deactivate the electrical power supply means 35 on the actuation of the electrical contact. More generally, the switch 23 forms an emergency stop botton of the robot 10′.

The switch 23 is for example formed by a pushbutton operated by displacement of the mobile part 28 in translation along an axis 37 relative to the fixed part 29. The force exerted on the abutment 22 and making it possible to actuate the switch 23 can be produced along the axis 37 or inclined relative to this axis. In case of inclination, it is the projection of the force on the axis 37 which actuates the switch 23. The given force of gauging of the abutment 22 is a force the direction of which is borne by the axis 37. It is therefore necessary to take this projection into account.

The force exerted by the head 1 on the abutment 22 can be oriented along the axis 27. This allows for a direct operation of the switch 23 without any projection of the force exerted on the abutment 22 at right angles to the axis 37. Alternatively, it is possible to tilt the axis 37 relative to the direction of the force exerted by the head 1 in order to facilitate other types of operation of the switch 23, for example performed by an operator capable of operating the switch 23 in case of emergency.

The robot 10′ is of humanoid type and the actuation of the switch 23 can be likened to an injury of the cervical spine. This injury can be indirect, that is to say due to an inappropriate movement of the head 1, or direct, that is to say due to a blow to the top of the torso 2 of the robot 10′. This type of injury is commonly called whiplash or a “rabbit punch” by analogy with a method used to kill a rabbit. It is a direct blow applied behind the nape of the rabbit. This blow produces an injury by hyper extension of the head leading to a fracture or a luxation of the cervical spine resulting in neurological issues and death by lesion of the medulla oblongata. The switch 23 is operated outside of operational operation of the robot and can to this end be likened to an involuntary or deliberate injury done to the robot 10′ and intended to rapidly stop it, for example by cutting its electrical power supply. The switch 23 can be a switch with one or two stable positions.

In the case of a switch 23 with a single stable position, a single impulse on the abutment 22 is sufficient to provoke the emergency stopping of the robot 10′. The switch can then control a bistable relay belonging to the electrical power supply means 35. Means for re-arming the electrical power supply of the robot 10′ are then provided in the electrical power supply means 35. The rearming control can be arranged at a distance from the abutment 22.

In the case of a switch 23 with two stable positions, the changeover from one stable position to the other directly provokes the cutting of the electrical power supply of the robot 10′. The re-arming of the electrical power supply is then done directly by the switch 23 by reverting to the first stable position. This re-arming operation can be performed by a means of a particular manipulation performed through the membrane 25.

FIG. 3 illustrates the actuation of the switch 23 by means of a rotational movement of the head 1 relative to the trunk 2 about an axis 21 substantially at right angles to the sagittal plane of the robot 10′. It is perfectly possible to provide for the triggering of the switch 23 for an excessive rotation of the head 1 relative to the trunk 2 about a horizontal axis of rotation contained in the sagittal plane. To this end, the spacer 27 can be in the form of a ring flange surrounding the neck 20. More generally, any force of the head 1 on the trunk 2 exceeding a given force, according to any axis of rotation in a horizontal plane 40 of the robot 10′ then brings about the actuation of the electrical contact of the switch 23.

To facilitate the obtaining of an item of electrical information in case of excessive force, it is possible to provide several switches 23 arranged under the ring flange 27. The triggering of at least one of the switches 23 bringing about the emergency stopping of the robot 10′. The ring flange 27 can be produced in the form of a single-piece ring or of several angular segments each associated with one of the switches 23. The single-piece ring or the different angular segments and more generally the ring flange 27 extend around a vertical axis 41 of the robot 10′. The vertical axis 41 is contained in the sagittal plane and is at right angles to the horizontal plane 40. The ring flange 27 can be arranged under the membrane 25 or can itself form a part of the skin of the trunk 2. The ring flange 27 ensures the transmission of the force of the head 1 against the abutment 22 to the mobile part 28 of the switch or switches 23.

FIG. 4 represents, in partial cross section, the robot 10′ in its sagittal plane. In this position, the head 1 and the trunk 2 are bearing one against the other on the abutment 22. FIG. 4 shows the robot in operational operation. The head 1 is positioned at one of the ends of the angular range α.

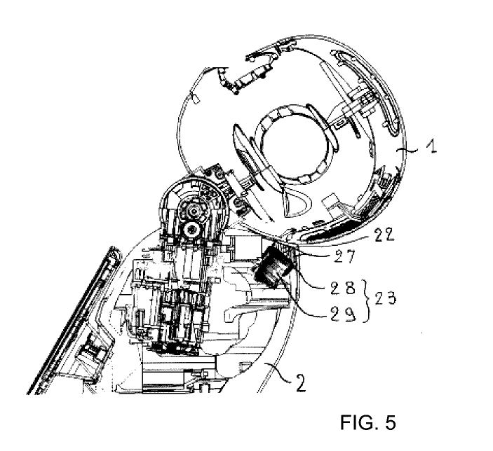

FIG. 5 represents, still in partial cross section, the robot 10′ in its sagittal plane. In the position of this figure, the robot has undergone an external action bringing about a force of the head 1 on the abutment 22 greater than the given value. This action can for example be a blow to the head 1, an impact on another part of the robot driving the head 1 by inertia against the abutment 22. In the position represented in FIG. 5, the ring flange 27 is deformed. Its deformation is not yet transmitted to the switch 23.

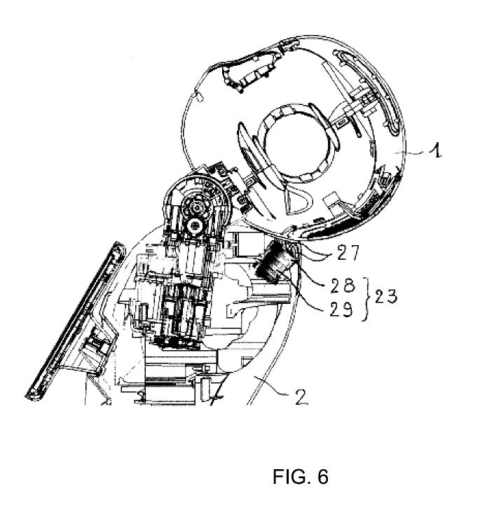

FIG. 6 shows the transmission of the force of the ring flange 27 to the switch, the mobile part 28 of which is displaced to operate the switch 23. The time separating the positions of FIGS. 5 and 6 can be of the order of a few milliseconds, the time necessary for the shockwave to be propagated in the ring flange 27.

1. A humanoid-type robot comprising two elements and an articulation with at least one degree of freedom linking the two elements, the articulation allowing a travel in a given range in operational operation, a first of the two elements being intended to come into contact with an abutment belonging to a second of the two elements at the end of the range, comprising at least one switch configured to actuate an electrical contact when a force exerted by the first element against the abutment exceeds a given force.

2. The device as claimed in claim 1, wherein the switch is situated in the abutment.

3. The robot as claimed in claim 1, wherein the two elements and the articulation are configured to deform at least one of the two elements or the articulation under the action of the force exceeding the given force, the deformation actuating the electrical contact.

4. The device as claimed in claim 1, wherein the abutment is flexible and the electrical contact is actuated by a deformation of the abutment.

5. The robot as claimed in claim 4, wherein the abutment has a stiffness characterizing its flexibility and in that the stiffness of the abutment is gauged to obtain the actuation of the electrical contact for a given force exerted on the abutment.

6. The robot as claimed in claim 1, comprising a flexible membrane forming a skin of the second element, the switch being arranged inside the second element under the skin.

7. The robot as claimed in claim 6, wherein the abutment comprises a spacer bearing on the one hand on a mobile part of the switch and on the other hand on the flexible membrane.

8. The robot as claimed in claim 1, wherein the switch comprises a mobile part and a fixed part fixed to a supporting structure of the second element and in that wherein the switch forms a pushbutton operated by displacement of the mobile part in translation along an axis relative to the fixed part.

9. The robot as claimed in claim 1, wherein the switch forms an emergency stop button of the robot.

10. The robot as claimed in claim 9, comprising electrical power supply means and wherein the electrical contact is configured to deactivate the electrical power supply means upon the actuation of the electrical contact.

11. The robot as claimed in claim 1, wherein the first of the two elements forms a head of the robot and the second of the two elements forms a trunk of the robot.

12. The robot as claimed in claim 11, wherein it is configured so that any force of the head on the trunk exceeding a given force according to any axis of rotation in a horizontal plane of the robot, actuates the electrical contact of the switch.

13. The robot as claimed in claim 12, wherein the abutment comprises a flange ring extending around a vertical axis of the robot, the flange ring ensuring the transmission of the force of the head against the abutment to the switch.

14. The robot as claimed in claim 12, wherein the abutment is arranged in a sagittal plane of the robot and wherein the electrical contact is arranged so as to be actuated upon a rotational movement of the head relative to the trunk about an axis substantially at right angles to the sagittal plane.
